(19) United States
(12) Patent Application Publication
(10) Pub. No.: US 2009/0151449 A1
(43) Pub. Date: Jun. 18, 2009

(54) SENSOR DEVICE STRUCTURE

(76) Inventors: Chung Chin HUANG, Taichung (TW); Hsin Ming Huang, Taichung (TW); Chin Ying Huang, Taichung (TW); Hsing Hsiung Huang, Taichung (TW); Chung Sheng Yen, Taichung City (TW); Kuan Chou Lin, Taichung (TW)

Correspondence Address: LEONG C LEI, PMB # 1008, 1867 YGNACIO VALLEY ROAD, WALNUT CREEK, CA, 94598, US

(21) Appl. No.: 11/958,390

(22) Filed: Dec. 18, 2007

(51) Int. Cl. G01D 11/24

(52) U.S. Cl. 73/431

(57) ABSTRACT

The sensor device has a casing housing a circuit board and a replaceable sensor on the circuit board. The casing has an opening corresponding to the sensor location and a manually removable cap is reliably positioned in the opening. Once the cap is removed, the sensor can be easily accessed and replaced. The cap is integrated with the casing smoothly so that the appealing of the outlook of the sensor device is minimally affected.

### (a) TECHNICAL FIELD OF THE INVENTION

The present invention generally relates to sensor devices, and more particularly to a structure for sensor devices so that the sensor can be easily accessed and replaced.

### (b) DESCRIPTION OF THE PRIOR ART

Various sensor devices such as oxygen sensors, CO2 sensors, CO sensors, temperature sensors, light detectors, etc., are commonly deployed. A common structure for these devices is that a sensor for a specific type of substance or energy is installed on a circuit board, which is in turn housed in a casing.

To maintain the accuracy of the sensor device, the sensor has to be removed from the circuit board for calibration or replaced with a new one after a period of use. Therefore, the casing is often assembled and disassembled. Moreover, the sensor devices are usually installed on the ceiling or other difficult-to-reach location, thereby making the job even more troublesome.

There are teachings that the sensor is exposed outside the casing for easy access and replacement. However, this approach would reduce the appealing of the device's outlook or ruin the room's interior decoration.

### SUMMARY OF THE INVENTION

Accordingly, a novel structure for sensor devices are provided herein to obviate the foregoing shortcomings of the prior art.

According to the present invention, a sensor is housed inside a casing of the sensor device. The casing has a reliably positioned yet manually removable cap so that, once the cap is removed, the sensor can be easily accessed and replaced. The cap is integrated with the casing smoothly so that the appealing of the outlook of the sensor device is minimally affected.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded diagram showing the various components of a sensor device according to an embodiment of the present invention.

FIG. 2 is a perspective exploded diagram showing the various components of the sensor device of FIG. 1 from a different viewing angle.

FIG. 3 is a perspective diagram showing the sensor device of FIGS. 1 and 2 after it is assembled.

FIG. 4 is a top-view diagram showing the sensor device of FIGS. 1 and 2 after it is assembled.

FIG. 5 is a sectional diagram showing the inside of the sensor device of FIGS. 1 and 2.

FIG. 6 is a schematic diagram showing the replacement of the sensor.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

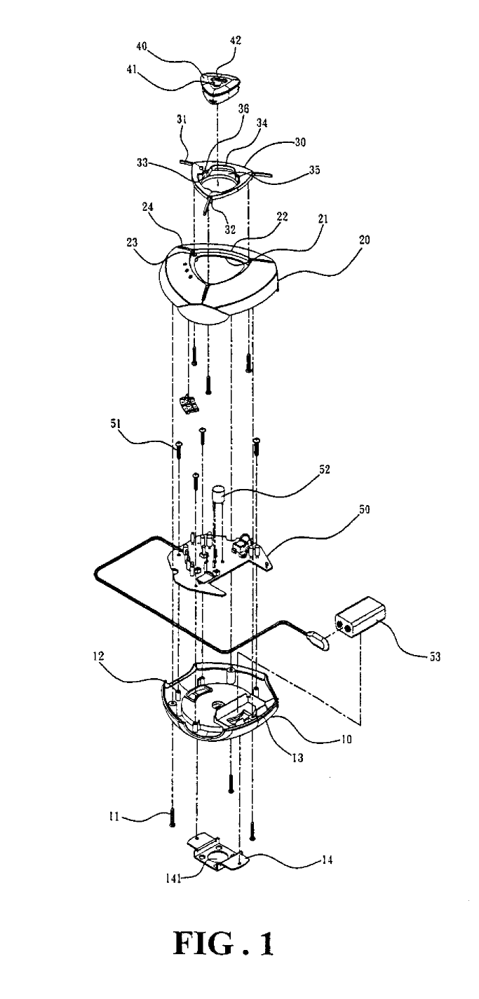

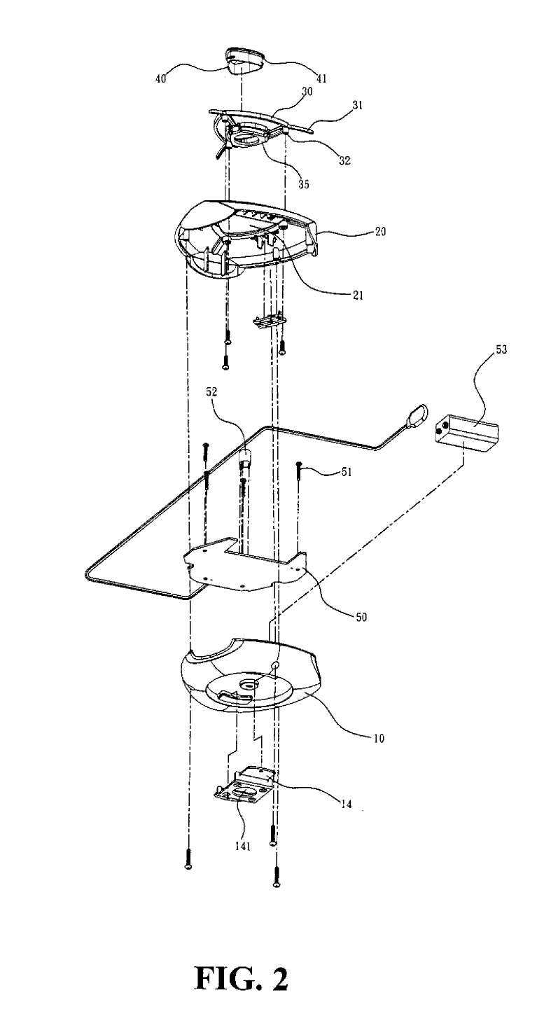

A sensor device according to an embodiment of the present invention, as shown in FIGS. 1 to 3, has a hollow casing formed by joining a first cover 10 to a second cover 20 with a number of bolts 11. A mounting piece 14 with a plug hole 141 is attached to an outside surface of the first cover 10 through which the sensor device could be fixed to a ceiling or a wall. The first cover 10 further has a battery chamber 13 inside and a number of bolt rods 12 are extended from inside the first cover 10 towards the second cover 20.

The second cover 20 has a substantially triangular through opening 21 in the center. The inner circumference of the opening 21 is surrounded with a substantially triangular flange 22. Three pin holes 23 are provided at the three vertices of the triangular flange 22, respectively. Three slits 24 are extended radially from the three vertices of the triangular opening 21 for an appropriate distance, respectively

A substantially triangular positioning piece 30 is housed inside the opening 21 and is supported by the flange 22. The positioning piece 30 has three blades 31 extended radially from its three vertices and accommodated in the slits 24, respectively. The positioning piece 30 also has three pins 32 that are housed inside the pin holes 23. Three bolts (not numbered) therefore can be screwed from the pin holes 23 into the pins 32 to tightly join the positioning piece 30 to the second cover 20. In the center of the positioning piece 30, there is also a through channel having a roughly triangular outer aperture 33 and a circular inner wall 35 with a smaller diameter. On the other hand, the triangular aperture 33 has three centripetal protrusions 36 from its three vertices and three centrifugal notches 34 from its three edges, respectively.

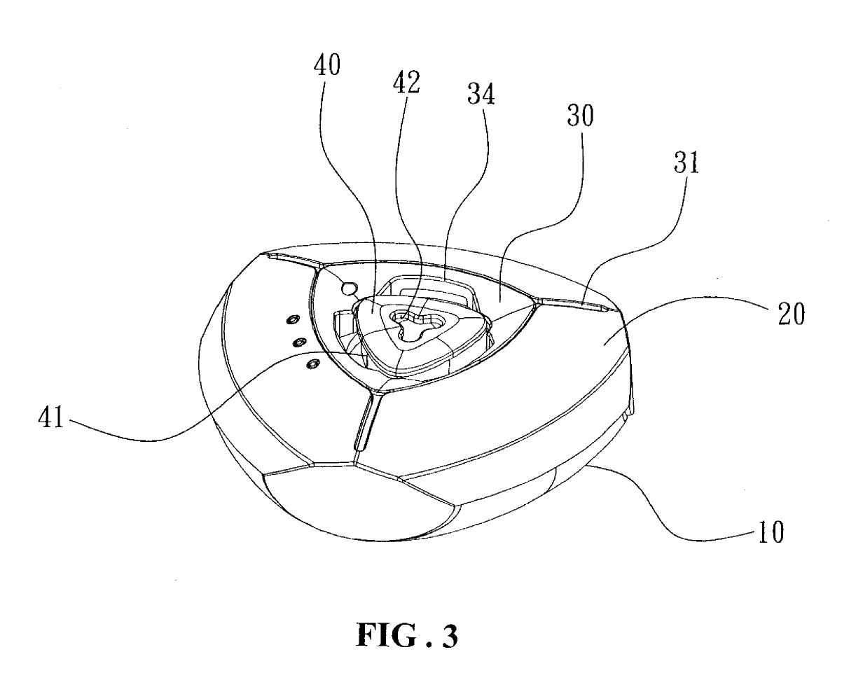

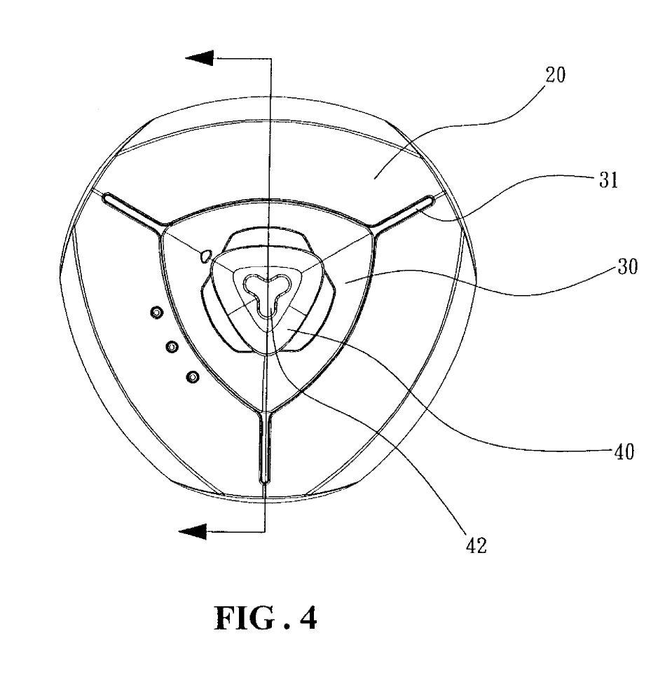

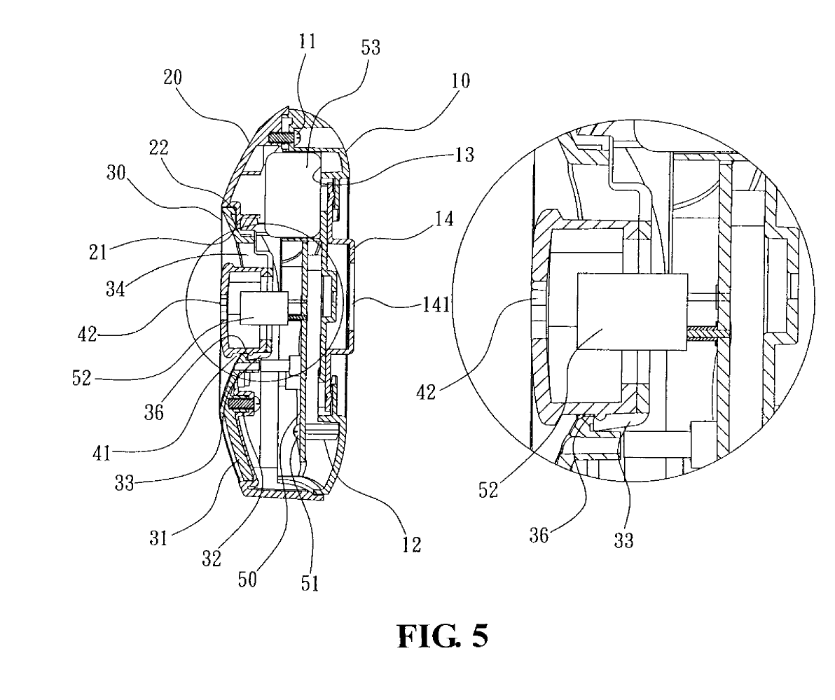

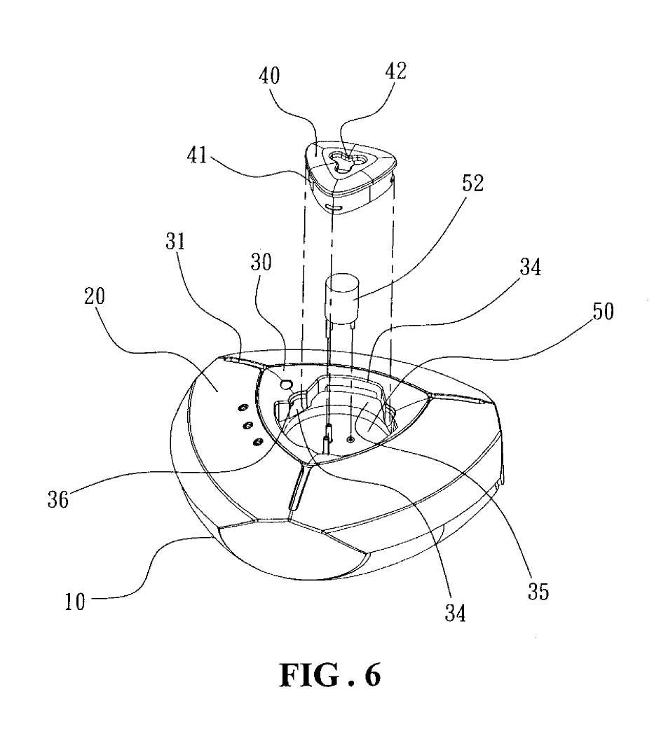

As further shown in FIGS. 3 to 6, a removable cap 40 is made of a flexible material and also has a substantially triangular shape. The removable cap 40 therefore could be accommodated in the aperture 33 and supported by the wall 35. Corresponding to the protrusions 36, the circumference of the removable cap 40 has grooves 41 so as to receive the protrusions 36, respectively. The center of the removable piece 40 has a Y-shaped indentation 42 so that a user can insert his or her finger into the indentation 42 and turn the removable piece 42. Once the protrusions 36 are not trapped in the grooves 41 and the vertices of the removable cap 40 are in the notches 34, the removable cap 40 could be easily separated from the sensor device. To put the removable piece 40 back, the user just reverses the foregoing procedure.

A circuit board 50 is housed inside the casing and is fixed to the bolt rods 12 by bolts 51. A sensor 52 is arranged on the circuit board 50 to be adjacent to the cap 40. The circuit board 50 has other electronic components for making the sensor 52 to function but they are not the subject matter of the present invention and therefore the details are omitted here. The circuit board 50 is powered by the electricity provided by a battery 53 in the battery chamber 13.

As described above, the opening 21 of the casing has a reliably positioned yet manually removable cap 40 so that, once the cap 40 is removed, the sensor 52 can be easily accessed, removed, or replaced. The cap 40 is integrated with the casing smoothly so that the appealing of the outlook of the sensor device is minimally affected.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure for a sensor device, comprising:
a hollow casing having an opening and a removable cap positioned inside said opening;
a circuit board housed inside said casing; and
a replaceable sensor on said circuit board adjacent to said opening;
wherein, once said cap is removed, said sensor is directly accessible from outside of said casing.

2. The structure according to claim 1, further comprising a positioning piece inside said opening; wherein said positioning piece has a through channel for accommodating said cap and allowing said cap to be manually removed and reinstalled.

3. The structure according to claim 2, wherein said hollow casing is formed by joining a first cover to a second cover; and said opening is on said second cover.

4. The structure according to claim 3, wherein an inner circumference of said opening is surrounded with a flange; a plurality of pin holes are provided along said flange; a plurality of slits are extended radially from said opening along an outside surface of said second cover; said positioning piece is housed inside said opening and is supported by said flange; said positioning piece has a plurality of blades extended radially and accommodated in said slits, said positioning piece has a plurality of pins housed inside said pin holes; a plurality of bolts are screwed from said pin holes into said pins to tightly join said positioning piece to said second cover; said through channel has an outer aperture and a circular inner wall with a smaller diameter; said aperture has a plurality of centripetal protrusions and centrifugal notches; said cap is made of a flexible material; said cap is accommodated in said outer aperture and supported by said inner wall; and said cap has a plurality of grooves along a circumference of said cap to receive said protrusions.

5. The structure according to clam 4, wherein said cap has an indentation on an outside surface for the exertion of force to remove said cap from said through channel.

6. The structure according to claim 3, further comprising a mounting piece attached to an outside surface of said first cover for fixing said sensor device to a flat surface.

7. The structure according to claim 3, wherein said first cover has a battery chamber inside and a plurality of bolt rods extended towards said second cover; said circuit board is fixed to said bolt rods by a plurality of bolts, respectively; and said circuit board is powered by a battery inside said battery chamber.

8. The structure according to claim 1, wherein said cap has an indentation on an outside surface for the exertion of force to remove said cap from said opening.
